(19) United States
(12) Patent Application Publication
(10) Pub. No.: US 2006/0066174 A1
(43) Pub. Date: Mar. 30, 2006

(54) Electrostatic actuator and image pickup apparatus

(76) Inventors: Toshikatsu Akiba, Kisarazu-shi (JP); Yasuo Shima, Kawasaki-shi (JP); Masayuki Sekimura, Chofu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/230,491

(22) Filed: Sep. 21, 2005

(30) Foreign Application Priority Data
Sep. 24, 2004 (JP) 2004-278274

(51) Int. Cl. H02N 1/00

(52) U.S. Cl. 310/309; 396/75; 348/374; 359/694

(57) ABSTRACT

In an electrostatic actuator, stoppers are provided on a driving electrode substrate. Stoppers are provided so that when a first movable section moves in the direction in which a penetrating portion penetrates a stator frame, a gap is created between driving electrodes and a movable-section driving electrode, with the stoppers lying opposite stoppers. This makes it possible to reduce the possibility of destroying the electrostatic actuator even if the movable section is deformed.

### CROSS-REFERENCE TO RELATED APPLICATIONS

This application is based upon and claims the benefit of priority from prior Japanese Patent Application No. 2004-278274, filed Sep. 24, 2004, the entire contents of which are incorporated herein by reference.

### BACKGROUND OF THE INVENTION

1. Field of the Invention

The present invention relates to an electrostatic actuator and an image pickup apparatus in which the electrostatic actuator for driving a lens is incorporated.

2. Description of the Related Art

In recent years, many efforts have been made to incorporate an image pickup apparatus with a zoom function or an auto focus function into mobile equipment such as a cellular phone. Such an image pickup apparatus drives a lens to adjust a focus to finally form an image on a sensor. Efforts have been made to use an electrostatic actuator as a driving source that drives the lens across an optical axis.

The image pickup apparatus can adjust a zoom scale factor and the focus by driving the lens. The electrostatic actuator comprises a stator and a movable section. The movable section holds the lens. Jpn. Pat. Appln. KOKAI Publication No. 2003-9550 discloses a known image pickup apparatus into which an electrostatic actuator is incorporated as described above. An image pickup apparatus having a lens unit in which lenses are incorporated into two movable sections are disclosed in Jpn. Pat. Appln. KOKAI Publication No. 2004-126009 and the corresponding U.S. patent application Ser. No. 10/672,409, filed Sep. 29, 2003, Koga et al.

In the above electrostatic actuator, the stator comprises a driving electrode substrate and a holding electrode substrate mounted on an upper and lower inner surfaces of a stator frame, respectively. The movable section is received in the stator so as to have a gap of several μm between the movable section and each of the electrode substrates. The movable section can thus reciprocate along the optical axis of the lens while moving up and down between the electrode substrates. The driving electrode substrate has driving electrodes for driving the movable section. The holding electrode substrate has holding electrodes for holding the movable section.

In the image pickup apparatus described above, the movable section is electrostatically driven by a switching circuit which supplies voltages to the electrodes on the electrode substrates of the stator in a predetermined order.

In the conventional image pickup apparatus, the movable section may disadvantageously be deformed by stress remaining in the movable section, a variation in temperature or humidity. The deformation of the movable section may bring the driving electrodes into contact with the movable section. This may cause a short circuit between the driving electrodes and the movable section. Therefore, the image pickup apparatus may be destroyed.

### BRIEF SUMMARY OF THE INVENTION

It is an object of the present invention to provide an electrostatic actuator that reduces the possibility of destroying an image pickup apparatus and an image pickup apparatus that is unlikely to be destroyed.

According to an aspect of the present invention, there is provided an electrostatic actuator comprising:
a stator;
a first and second substrates arranged in the stator so as to be faced each other, the second substrate being provided with first convex portions;
a movable section guided in the stator so as to be movable in a predetermined direction, the movable section being provided with second convex portions which are faced to the first convex portions, respectively;
a holding electrode provided on the first substrate to attract and hold the movable section;
first electrodes provided on the second substrate at a first pitch in the predetermined direction; and
second electrodes provided on the movable section at a second pitch in the predetermined direction, which is faced to the first electrodes so as to drive the movable section, the first and second convex portions forming a gap between the first electrodes and the second electrodes.

According to another aspect of the present invention, there is provided an image pickup apparatus comprising:
a stator;
a first and second substrates arranged in the stator so as to be faced each other, the second substrate being provided with first convex portions;
a movable section guided in the stator so as to be movable in a predetermined direction, the movable section being provided with second convex portions which are faced to the first convex portions, respectively;
a holding electrode provided on the first substrate to attract and hold the movable section;
first electrodes provided on the second substrate at a first pitch in the predetermined direction;
second electrodes provided on the movable section at a second pitch in the predetermined direction, which is faced to the first electrodes so as to drive the movable section, the first and second convex portions forming a gap between the first electrodes and the second electrodes;
a lens provided in the movable section to transfer an image of a subject; and
an image pickup device arranged to detect the image of the subject transferred from the lens.

### BRIEF DESCRIPTION OF THE SEVERAL VIEWS OF THE DRAWING

FIG. 1 is a perspective view schematically showing an image pickup apparatus using an electrostatic actuator according to a first embodiment of the present invention;

FIG. 2 is an exploded perspective view schematically showing the image pickup apparatus using the electrostatic actuator shown in FIG. 1;

FIG. 3A is a plan view showing a driving electrode substrate incorporated into the electrostatic actuator shown in FIGS. 1 and 2;

FIGS. 3B and 3C are partly enlarged plan views showing the driving electrode substrate shown in FIG. 3A;

FIG. 3D is a plan view schematically showing a holding electrode substrate incorporated into the electrostatic actuator shown in FIGS. 1 and 2;

FIGS. 4A to 4H are sectional views schematically showing a process of manufacturing the driving electrode substrate and holding electrode substrate incorporated into the electrostatic actuator shown in FIGS. 1 and 2;

FIG. 5 is a perspective view schematically showing a first movable section in the electrostatic actuator shown in FIGS. 1 and 2;

FIGS. 6A and 6B are a front view and a side view of a part of the first movable section shown in FIG. 5 which part is shown by reference character A;

FIGS. 7A and 7B are a front view and a side view of a part of the first movable section shown in FIG. 5 which part is shown by reference character B;

FIG. 8 is a sectional view schematically showing the electrostatic actuator shown in FIGS. 1 and 2;

FIG. 9 is a perspective view schematically showing a first movable section constituting an electrostatic actuator in an image pickup apparatus according to a second embodiment of the present invention;

FIGS. 10A and 10B are a front view and a side view of a part of the first movable section shown in FIG. 9 which part is shown by reference character A;

FIGS. 11A and 11B are a front view and a side view of a part of the first movable section shown in FIG. 9 which part is shown by reference character B; and

FIG. 12 is a perspective view schematically showing a variation of the first movable section shown in FIG. 9.

### DETAILED DESCRIPTION OF THE INVENTION

With reference to the drawings, description will be given of an image pickup apparatus into which an electrostatic actuator according to embodiments of the present invention is incorporated.

### First Embodiment

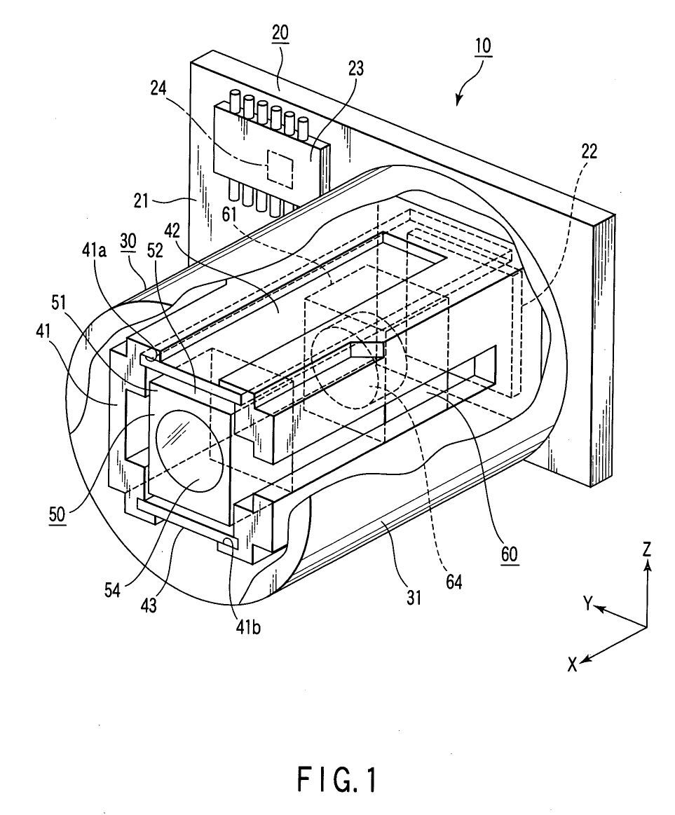

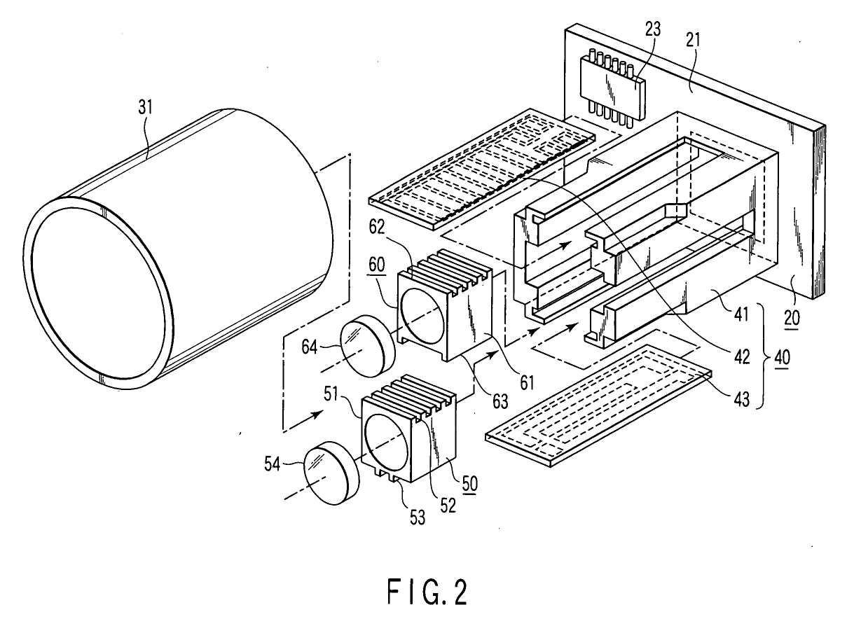

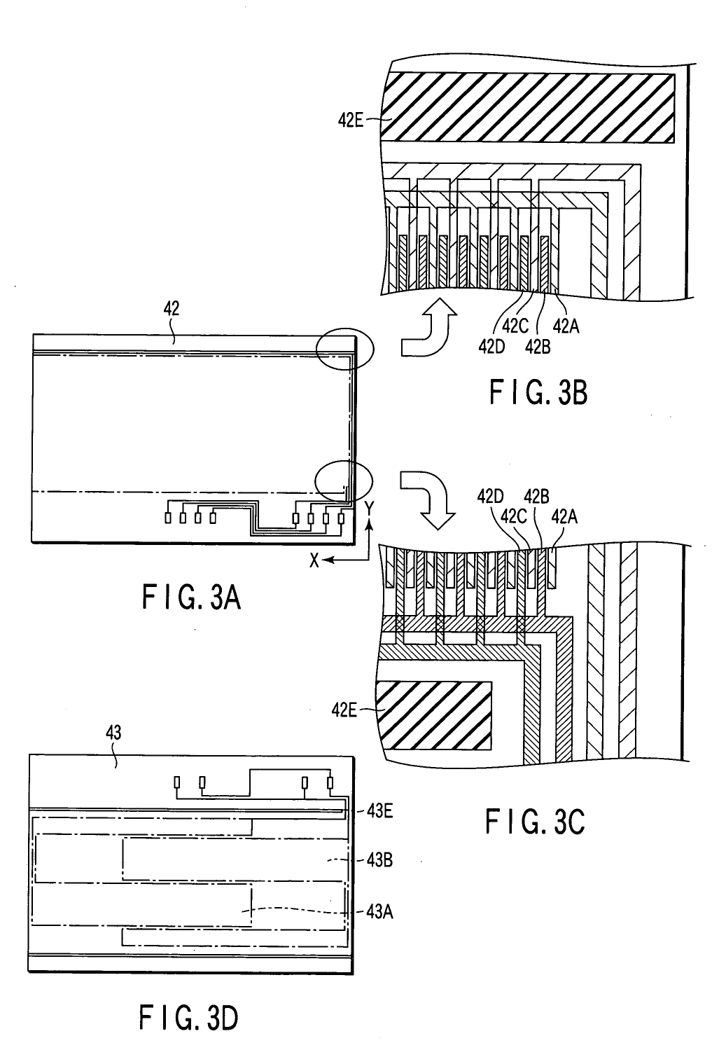

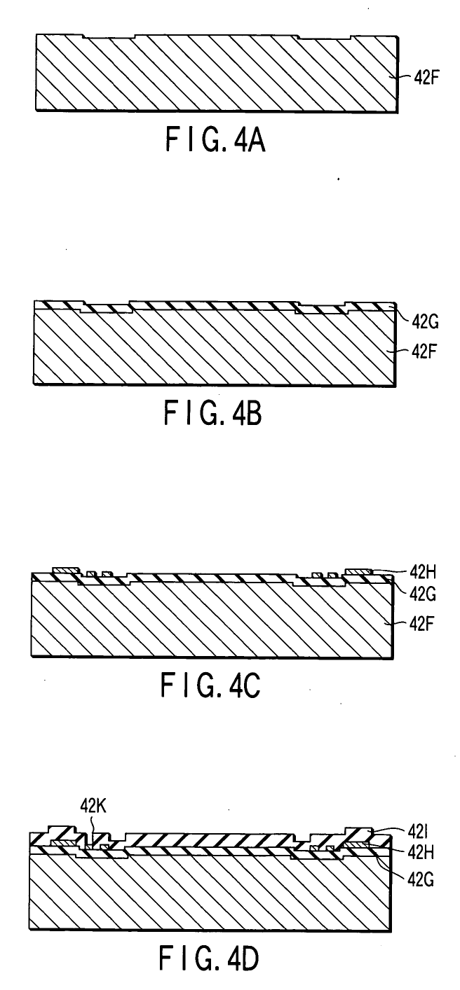

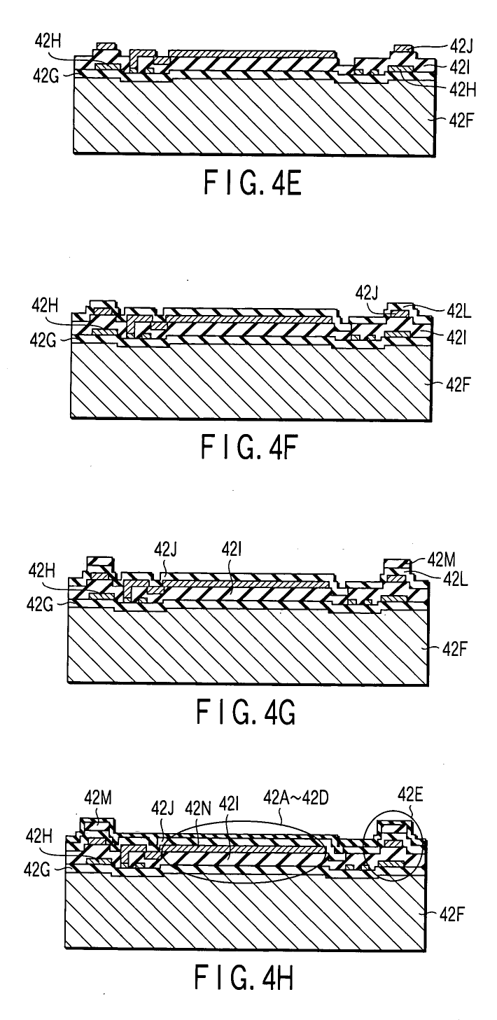

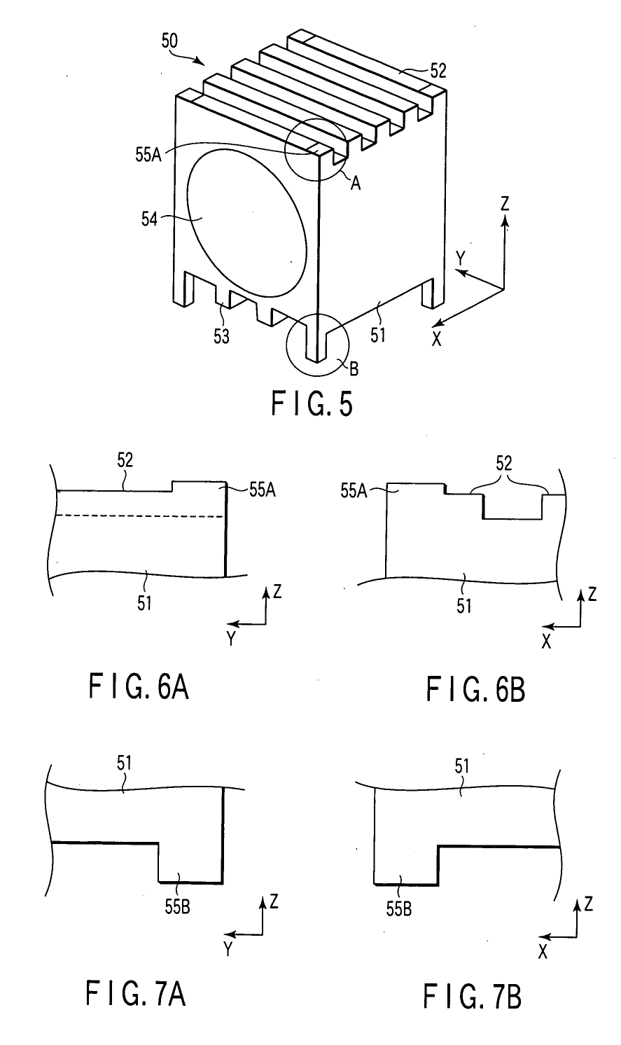

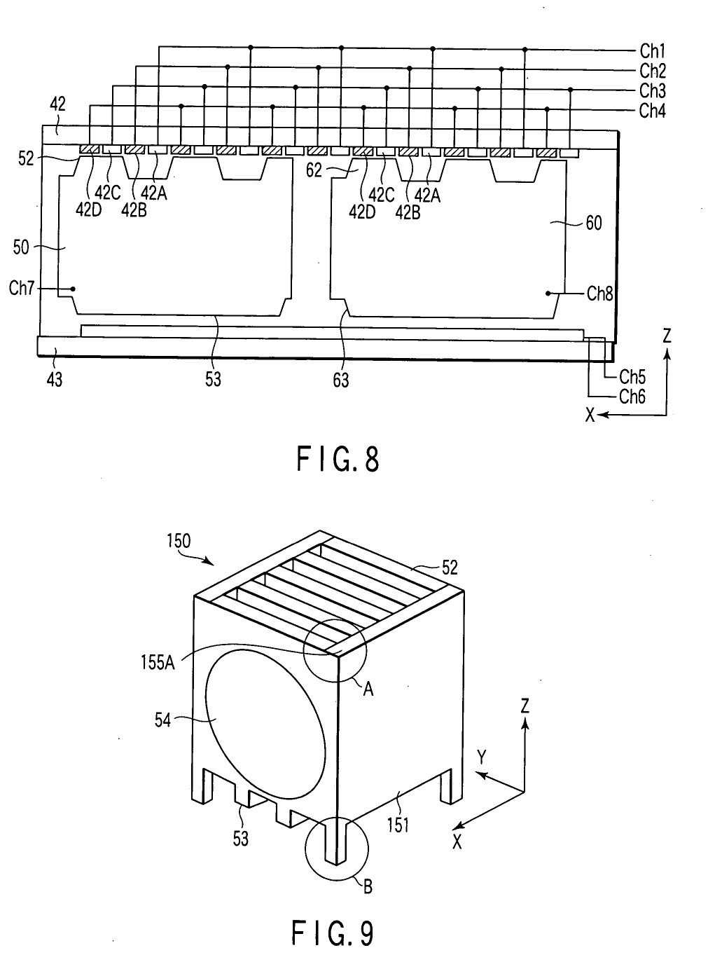

FIG. 1 is a partly cutaway perspective view schematically showing an image pickup apparatus into which an electrostatic actuator according to a first embodiment of the present invention is incorporated. FIG. 2 is an exploded perspective view of the image pickup apparatus 10 shown in FIG. 1. FIG. 3A is a plan view schematically showing a driving electrode substrate 42 in the electrostatic actuator shown in FIGS. 1 and 2. FIGS. 3B and 3C are partly enlarged plan views of the driving electrode substrate 42, shown in FIG. 3A. FIG. 3D is a plan view schematically showing a holding electrode substrate 43 in the electrostatic actuator shown in FIGS. 1 and 2. FIGS. 4A to 4D are sectional views schematically showing a process of manufacturing the driving electrode substrate 42 and holding electrode substrate 43, incorporated into the electrostatic actuator shown in FIGS. 1 and 2. FIG. 5 is a perspective view schematically showing a first movable section 50 incorporated into the electrostatic actuator shown in FIGS. 1 and 2. FIGS. 6A and 6B are a front view and a side view of a part of the first movable section 50 shown in FIG. 5 which part is shown by reference character A. FIGS. 7A and 7B are a front view and a side view of a part of the first movable section 50 shown in FIG. 5 which part is shown by reference character B. FIG. 8 is a sectional view schematically showing the electrostatic actuator shown in FIGS. 1 and 2.

In FIGS. 1 to 4, arrows X, Y, Z show three orthogonal directions. In particular, arrow X corresponds to the direction in which a penetrating portion extends penetratingly through the stator frame 41 and also to the direction in which a first and second movable sections 50 and 60 move. In the description of the embodiments, arrow Z in FIG. 1 is assumed to show an upward direction. In FIG. 3A, patterns 42A to 42D are simplified because they cannot be expressed in a diagram if they are drawn very precisely.

The image pickup apparatus 10 comprises the zoom lens unit 30 that transmits an image of a subject according to a zoom scale factor and an image pickup element section 20 that photographs the transmitted subject image. The zoom lens unit 30 includes lenses 54 and 64 described below to transmit the subject image according to a predetermined zoom ratio. The image pickup apparatus 10 comprises the image pickup element section 20 and the zoom lens unit 30. The image pickup element section 20 comprises a substrate 21, and a sensor 22 such as a CCD and a controlling electronic part 23 which are arranged on the substrate 21; the subject image is formed on the sensor, which thus detects the subject image. A driving control circuit 24 is incorporated into the electronic part 23 to drive the zoom lens unit 30, composed of an electrostatic actuator and described later.

The zoom lens unit 30 comprises a cylindrical cover 31 internally having a cavity portion extending in the direction X, a stator 40 fixed in the cavity portion, and a first movable section 50 and a second movable section 60 independently driven in the stator 40, as shown in FIGS. 1 and 2. The first and second movable sections 50 and 60 are inserted and arranged in the stator frame 41 so that they can move along the direction X of the optical axis while being separated from each other.

The stator 40 comprises a stator frame 41 that is a hollow, parallelepiped frame having a cavity portion. The stator frame 41 has an upper inner surface 41A and a lower inner surface 41B located opposite each other. The driving electrode substrate 42 is attached to the upper inner surface 41A to drive the first and second movable sections 50 and 60. Moreover, a holding electrode substrate 43 is attached to the lower inner surface 41B to hold the movable sections 50 and 60 at particular positions.

The cylindrical cover 31 or stator frame 41 is sealed and maintained in a vacuum, air-tight state by a sealing member (not shown); external dust, moisture, or the like is prevented from entering the cylindrical cover 31 or stator frame 41. For example, a glass plate 70 may be used to seal the front surface of the cylindrical cover 31. The sealed space may be maintained in a substantially vacuum state. Also a dry air or an inert gas such as a nitrogen gas may be sealed into the sealed space. Thus, the first and second movable sections 50 and 60 and the driving and holding electrode substrates 42 and 43 are arranged in the vacuum space or the space into which the inert gas is sealed. This prevents discharge from occurring readily between each of the first and second movable sections 50 and 60 and the driving and holding electrode substrates 42 and 43 even if a potential difference is applied to between them.

As shown in FIG. 3C, plural groups of electrodes 42A to 42D are formed on a surface of the driving electrode substrate 42, made of an insulating material; the electrodes 42A to 42D are patterned in a desired shape in order to drive the first movable section 50. In the groups of electrodes 42A to 42D, the electrodes 42A to 42D extends in a direction Y orthogonal to the moving direction X. The electrodes 42A to 42D are arranged in the moving direction X. The insulating material substrate may be, for example, a glass plate, or an insulating substrate for a printed circuit board such as a silicon wafer, aramid, or glass epoxy which has a thermal oxide film formed on its surface. Each of the electrodes has a width of several μm to several tens of μm. The spacing between the electrodes is several μm to several tens of μm. The electrodes are arranged at a fixed pitch. The fixed pitch includes a machining error resulting from machining.

As described later, the driving electrodes 42A to 42D are covered with an insulating layer and connected to the driving control circuit 24 of the electronic part 23. The driving control circuit 24 inputs a control voltage signal to the driving electrodes 42A to 42D to drive them. Specifically, the voltage signal is input independently to each group of driving electrodes 42A to 42D. If the voltage signal is input to, for example, the driving electrode 42A, it is applied to the convex pattern corresponding to the driving electrodes 42A in all the groups on the driving electrode substrate 42. Here, the driving electrodes 42A correspond to a channel 1 (ch1) and the driving electrodes 42B correspond to a channel 2 (ch2). The driving electrodes 42C correspond to a channel 3 (ch3) and the driving electrodes 42D correspond to a channel 4 (ch4).

A convex stopper 42E is provided on the driving electrode substrate 42. The stopper 42E is provided on a surface of the driving electrode substrate 42 on which the driving electrodes 42A to 42D are disposed. The stopper 42E is higher than the driving electrodes 42A to 42D.

The driving electrode substrate is formed using a manufacturing process shown in FIGS. 4A to 4H. First, as shown in FIG. 4A, a concave portion is formed on a part of a base material 42F such as a silicon wafer using for example, an etching method such as RIE. A step described later is then executed to form, on the concave portion, a stacked structure including the driving electrodes 42A to 42D on the driving electrode substrate and interconnects connecting the driving substrates 42A to 42D to the driving control circuit 24.

The interconnects are arranged in a concave portion formed in the stacked structure in association with the above concave portion. As a result, the interconnects are prevented from coming into direct contact with the first movable section 50 or the second movable section 60.

Then, as shown in FIG. 4B, an insulating layer 42G such as SiO₂ is formed on the base material 42F. The insulating layer 42G is provided to allow the base material 42F to tightly contact other layers subsequently formed. If the base material 42F is a silicon wafer, the insulating layer 42F is provided to insulate the base material 42F from other layers subsequently formed. The insulating layer 42G can be formed by for example, using an oxidation furnace to oxidize the surface of the silicon wafer.

Subsequently, as shown in FIG. 4C, a conductive layer 42H is selectively formed on the insulating layer 42G. The conductive layer 42H can be formed by for example, using a sputtering method to deposit an Al—Si—Cu layer, using an exposure development technique to form a resist layer on the surface of a desired part of the conductive layer 42H, and then using the etching method such as RIE to carry out patterning and resist removal.

Then, as shown in FIG. 4D, the conductive layer 42H is selectively formed on the insulating layer 42G. An insulating layer 42I is formed on the conductive layer 42H and insulating layer 42G. A via hole 42K is formed in the insulating layer 42I so as to connect to a conductive layer 42J subsequently formed. The insulating layer 42I is formed by for example, executing a CVD method with TEOS or SiH₄ to deposit an SiO₂ film. The via hole 42K can be formed by using the exposure development technique to form a resist layer on the surface of a desired part of the insulating layer 42I and then using the etching method such as RIE to carry out patterning and resist removal.

As shown in FIG. 4E, a conductive layer 42J is selectively formed on the insulating layer 42I. The conductive layer 42J can be formed by for example, using the sputtering method to deposit an Al—Si—Cu layer, using the exposure development technique to form a resist layer on the surface of a desired part of the conductive layer 42J, and then using the etching method such as RIE to carry out patterning and resist removal.

As shown in FIG. 4F, an insulating layer 42L is formed on the insulating layer 42I on which the conductive layer 42J has been selectively formed as well as on the conductive layer 42J. The insulating layer 42L is formed by for example, executing the CVD method with TEOS or SiH₄ to deposit an SiO₂ film.

Moreover, as shown in FIG. 4G, an insulating layer 42M is formed on the insulating layer 42L. The insulating layer 42M is selectively provided in a part corresponding to the stopper 42E. The insulating layer 42M is formed by for example, using the CVD method to deposit an SiN film. The insulating layer 42M can be formed by for example, using the exposure development technique to form a resist layer on the surface of a desired part of the insulating layer 42M and then using the etching method such as RIE to carry out patterning and resist removal.

Finally, as shown in FIG. 4H, a surface protect layer 42N is formed on the insulating layer 42M, on which the insulating layer 42L has selectively been formed. A dicing method is used to cut and shape the silicon wafer into the driving electrode substrate 42, which is then divided into electrodes. The surface protect layer 42N can be formed by for example, executing the CVD method to deposit an SiN film.

For example, the base material 42F has a thickness of 725 μm, the insulating layer 42G/insulating layer 42I has a thickness of 1.1 μm, and the conductive layer 42H/conductive layer 42J has a thickness of 0.6 μm. The insulating layer 42L has a thickness of 0.5 μm, and the insulating layer 42M/insulating layer 42N has a thickness of 0.55 μm. The concave portion formed in the base material 42F has a depth of for example, 0.6 μm.

The holding electrode substrate 43 is formed of an insulating material substrate having a desired shape patterned on its surface as shown in FIG. 3D. Stripe electrodes 43A and 43B are formed in parallel over the range within which the first and second movable sections 50 and 60 move; the stripe electrode 43A corresponds to a first movable section electrode 53 on the first movable section 50, and the stripe electrode 43B corresponds to a second movable section electrode 63 (described below) on the second movable section 60. The insulating substrate may be, for example, a glass plate, or an insulating substrate for a printed circuit board such as a silicon wafer, aramid, or glass epoxy which has a thermal oxide film formed on its surface. Here, the second movable section stripe electrode 43B corresponds to a channel 5 (ch5), and the first movable section stripe electrode 43A corresponds to a channel 6 (ch6). The stripe electrodes 43A and 43B are electrically independently arranged so as to independently control the first and second movable sections 50 and 60.

Like the driving electrode substrate 42, the holding electrode substrate 43 is provided with a stopper 43E. The holding electrode substrate 43 can be manufactured using a process similar to that used for the driving electrode substrate 42 and described with reference to FIGS. 4A to 4H. Accordingly, the detailed description of the process of manufacturing the holding electrode substrate 43 is omitted.

The first movable section 50 comprises a substantially parallelepiped support 51 formed of a conductive material having a hollow portion extending in the direction X as shown in FIGS. 1 and 2. The support 51 can be formed by, for example, physically grinding or chemically etching a conductive material.

Alternatively, the support 51 may be formed by injecting a conductive resin. A movable section driving electrode 52 is formed on the top surface of the support 51 in association with the electrodes 42A to 42D as shown in FIG. 4. The first movable section electrode 53 is formed on the bottom surface of the support 51 in association with the stripe electrode 43A. Moreover, a lens 54 is fixed to the hollow portion.

As shown in FIGS. 6A and 6B, stoppers 55A are formed in corners of the surface of the movable-section driving electrode 52 as concave portions projected from the surface of the movable-section driving electrode 52. The stoppers 55A are provided so that when the first movable section 50 moves in the direction X of the optical axis, a gap is created between the driving electrodes 42A to 42D and the movable-section driving electrode 52, with the stoppers 55A lying opposite the stoppers 42E.

For a design value for the gap between the driving electrodes 42A to 42D and the movable-section driving electrode 52, the minimum value is 3 μm and the maximum value is 15 μm when the first movable section 50 moves in the optical axis direction X. The design value does not contain an error resulting from machining or assembly of the support 51, driving electrode substrate 42, or holding electrode substrate 43. For example, with the above method for manufacturing the driving electrode substrate 42 and holding electrode substrate 43, about 1.0 μm to 3.0 μm is a suitable value for the height of the stopper 55A from the surface of the movable-section driving electrode 52.

As shown in FIGS. 7A and 7B, stoppers 55B are formed in corners of the bottom surface of the support 51 so as to project from the bottom surface. The stoppers 55 are provided so that when the first movable section 50 moves in the direction X of the optical axis, a gap is created between both stripe electrodes 43A and 43B and the first movable-section driving electrode 53, with the stoppers 55B lying opposite the stoppers 43E.

If the support 51 is made of a conductive resin, the conductive resin may be, for example, a conductive PPS or a conductive PS resin. The conductive PPS resin is particularly preferably used as the material for the support 51 because of its electrical characteristics and moldability. Further, it is preferable to add a fluorine-based material (for example, PTEE), or potassium titanate, oil, or carbon fiber to the conductive PPS resin in order to reduce the coefficient of friction. It is possible to add any one of the fluorine-based material, potassium titanate, oil, and carbon fiber. However, it is also possible to add a plurality of additives, for example, PTFE and oil.

If a conductive resin is molded into the movable section 50, the stoppers 55A and 55B can be integrally formed with the first movable section 50. Alternatively, conductive films may be selectively stacked on surface regions of the first movable section 50 to form the stoppers 55A and the stoppers 55B. End faces of the stoppers 55A and the stoppers 55B are preferably coated with a film having a high degree of hardness such as a diamond like carbon (DLC) film. Accordingly, the DLC films may be selectively stacked on the surface regions of the first movable section 50 to form the stoppers 55A and the stoppers 55B.

The movable-section driving electrode 52 is composed of a plurality of projection-like stripes extended orthogonally to the direction X in which the first movable section 50 moves; the concave and convex stripes are arranged in parallel in the moving direction X. The stripes correspond to the concave and convex portions formed on the surface of the electrode 52. The spacing between the stripes is set at for example, about 32 μm. The height of each convex portion is set at about 10 μm from the surface in each concave portion. The height may be at least 10 μm and may thus be larger than 10 μm. The width of each convex of the movable section driving electrode 52 is equal to double the pitch of the driving electrodes 42A to 42D. The bottom surface of each concave of the movable section driving electrode 52 is specified to have a width equal to double the pitch of the driving electrodes 42A to 42D. If the driving electrode substrate 42 is a silicon wafer having a thermal oxide film formed on its surface, the concaves or convexes of the movable section driving electrode 52 are arranged at a pitch of about 64 μm.

The first movable section electrode 53 is composed of a plurality of projection-like stripes formed by etching; the stripes are extended in the moving direction of the first movable section 50 so as to lie opposite the electrode 43A, and are arranged in parallel in the direction Y. Here, the first movable section 53 corresponds to a channel 7 (ch7).

The first movable section 60 comprises a substantially parallelepiped support 61 formed of a conductive material having a hollow portion as shown in FIGS. 1 and 2. The support 61 can be formed by, for example, physically grinding or chemically etching a conductive material. Alternatively, the support 61 may be formed by injecting a conductive resin. A movable section driving electrode 62 is formed on the top surface of the support 61. The second movable section electrode 63 is formed on the bottom surface of the support 61. Moreover, a lens 64 is fixed to the hollow portion.

The movable driving electrode 62 is formed on the top surface of the second movable section 60 as shown in FIG. 4. The movable section driving electrode 62 is formed as a plurality of stripes composed of concaves and convexes arranged in parallel in the moving direction X. The stripes are formed, by etching, like projections extended orthogonally to the moving direction X of the second movable section 60. The spacing between the stripes is, for example, about 32 μm. The height of each convex portion is set at about 10 μm from the surface in each concave portion. The height may be at least 10 μm and may thus be larger than 10 μm. That is, the width of each convex of the movable section driving electrode 62 is equal to double the pitch of the driving electrodes 42A to 42D. The bottom surface of each concave of the movable section driving electrode 62 has a width equal to double the pitch of the driving electrodes 42A to 42D. If, for example, the driving electrode substrate 42 is a silicon wafer having a thermal oxide film formed on its surface, the concaves or convexes of the movable section driving electrode 62 are arranged at a pitch of about 64 μm.

The second movable section electrode 63 is composed of a plurality of projection-like stripes formed by etching; the stripes are extended in the moving direction of the first movable section 50 so as to lie opposite the electrode 43B, and are arranged in parallel in the direction Y. Here, the second movable section 63 corresponds to a channel 8 (ch8).

The electrodes shown in FIG. 8 are driven to change the above arrangement of the lens 54 in the first movable section 50 and the lese 64 in the second movable section 60. A lens system composed by these lenses is zoomed between a wide side and a tele side. The focus of the subject is adjusted on the basis of the focal distance determined by the zooming.

In the image pickup apparatus 10 configured as described above, the first and second movable sections 50 and 60 are driven as described below.

To drive the first movable section 50, a potential difference is applied to between the driving electrodes 42A to 42D and the movable section electrode 52 and to between the stripe electrode 43A and the first movable section electrode 53. Then, an electrostatic force is exerted between the driving electrodes 42A to 42D and the movable section electrode 52 and between the stripe electrode 43A and the first movable section electrode 53. The electrostatic force attracts these electrodes to one another. The first movable section 50 can be moved by switching the target of potential difference application between the driving electrodes 42A to 42D and the stripe electrode 43A, as disclosed in, for example, Jpn. Pat. Appln. KOKAI Publication No. 2004-126009 and the corresponding U.S. patent application Ser. No. 10/672,409, filed Sep. 29, 2003, Koga et al. The U.S. patent application Ser. No. 10/672,409 is incorporated into the specification and will not be described below.

On the other hand, to drive the second movable section 60, a potential difference is applied to between the driving electrodes 42A to 42D and the movable section electrode 62 and to between the stripe electrode 43B and the second movable section electrode 63. Then, an electrostatic force is exerted between the driving electrodes 42A to 42D and the movable section electrode 62 and between the stripe electrode 43B and the second movable section electrode 63. The electrostatic force attracts these electrodes to one another. Like the first movable section 50, the second movable section 60 can be moved by switching the target of potential difference application between the driving electrodes 42A to 42D and the stripe electrode 43B.

To hold the first movable section 50, a potential difference is applied to between the stripe electrode 43A and the first movable section electrode 53. Then, an electrostatic force is exerted between the stripe electrode 43A and the first movable section electrode 53. The electrostatic force attracts these electrodes to each other, thus enabling the first movable section 50 to be held. To hold the second movable section 60, a potential difference is applied to between the stripe electrode 43B and the second movable section electrode 63 as in the case of the first movable section 50.

In the image pickup apparatus 10 and zoom lens unit 30 configured as described above, each of the stoppers 55A is provided opposite the corresponding stopper 42E. This configuration can reduce the possibility of the following phenomenon even if the first movable section 50 is deformed by stress remaining in it or a variation in temperature or humidity: the driving electrodes 42A to 42D come into contact with the first movable section 50 to cause a short circuit between the driving electrodes 42A to 42D and the first movable section 50, thus damaging the image pickup apparatus 10.

Further, each stopper 55A is provided opposite the corresponding stopper 42E. This minimizes the magnitude of the dimensional error between the stopper 42E and the stopper 55A. If only the stoppers 42E or 55A are provided, when the height of the stoppers 42E or 55A is increased to avoid the contact between the driving electrodes 42A to 42D and the first movable section 50, the magnitude of the dimensional error increases.

The stoppers 42E are provided using, for example, such a thin film process as shown in FIGS. 4A to 4H. To increase the height of the stoppers 42E, it is necessary to increase the thickness of each layer or the number of layers of thin films. However, an increase in the thickness of each layer or in the number of thin film layers may increase the magnitude of an error in height of the stoppers 42E. Further, in this case, film stress may cause the driving electrode substrate 42 to be warped. This increases the possibility of contacting the driving electrodes 42A to 42D with the first movable section 50.

Further, for example, the stoppers 55A are formed by injecting a conductive resin such as PPS. One of the dimensional errors in injection molding is molding shrinkage. Molding shrinkage results from the ratio of the dimensions of the molding. That is, higher stoppers 55A are accompanied by more significant molding shrinkage. This may increase the possibility of contacting the driving electrodes 42A to 42D with the first movable section 50.

Accordingly, the magnitude of the dimensional error between the stopper 42E and the stopper 55A is minimized by providing each stopper 55A opposite the corresponding stopper 42E. This configuration can reduce the possibility of the following phenomenon even if the first movable section 50 is deformed by stress remaining in it or a variation in temperature or humidity: the driving electrodes 42A to 42D come into contact with the first movable section 50 to cause a short circuit between the driving electrodes 42A to 42D and the first movable section 50, thus damaging the image pickup apparatus 10.

Further, for the design value for the gap between the driving electrodes 42A to 42D and the movable-section driving electrode 52, the minimum value is 3 μm when the first movable section 50 moves in the optical axis direction X. This configuration can reduce the possibility of the following phenomenon even if the first movable section 50 is deformed by stress remaining in it or a variation in temperature or humidity: the driving electrodes 42A to 42D come into contact with the first movable section 50 to cause a short circuit between the driving electrodes 42A to 42D and the first movable section 50, thus damaging the image pickup apparatus 10.

Furthermore, each stopper 55B is provided opposite the corresponding stopper 43E. As in the case of the stoppers 42E and 55A, this configuration can reduce the possibility of the following phenomenon even if the first movable section 50 is deformed by stress remaining in it or a variation in temperature or humidity: the driving electrodes 42A to 42D come into contact with the first movable section 50 to cause a short circuit between the driving electrodes 42A to 42D and the first movable section 50, thus damaging the image pickup apparatus 10.

Further, each stopper 55B is provided opposite the corresponding stopper 43E. As in the case of the stoppers 42E and 55A, this configuration allows the first movable section 50 to move more smoothly.

In the description of the first embodiment, the stoppers 55A and 55B are provided only on the first movable section 50. However, the stoppers may be provided on the second movable section 60.

Specifically, the stoppers may also be provided on the surface of the movable-section driving electrode 62. The stoppers may be provided so that when the second movable section 60 moves in the direction X of the optical axis, a gap is created between the driving electrodes 42A to 42D and the movable-section driving electrode 62, with the stoppers lying opposite the stoppers 42E.

For the design value for the gap between the driving electrodes 42A to 42D and the movable-section driving electrode 62, the minimum value is 3 μm and the maximum value is 15 μm when the second movable section 60 moves in the optical axis direction X. The design value does not contain an error resulting from machining or assembly of the support 61, driving electrode substrate 42, or holding electrode substrate 43. For example, with the above method for manufacturing the driving electrode substrate 42 and holding electrode substrate 43, about 1.0 μm to 3.0 μm is a suitable value for the height of the stoppers from the surface of the movable-section driving electrode 62.

Specifically, the stoppers may also be provided on the surface of the support 61. The stoppers may be provided so that when the second movable section 60 moves in the direction X of the optical axis, a gap is created between the stripe electrodes 43A and 43B and the second movable-section electrode 63, with the stoppers lying opposite the stoppers 43E.

### Second Embodiment

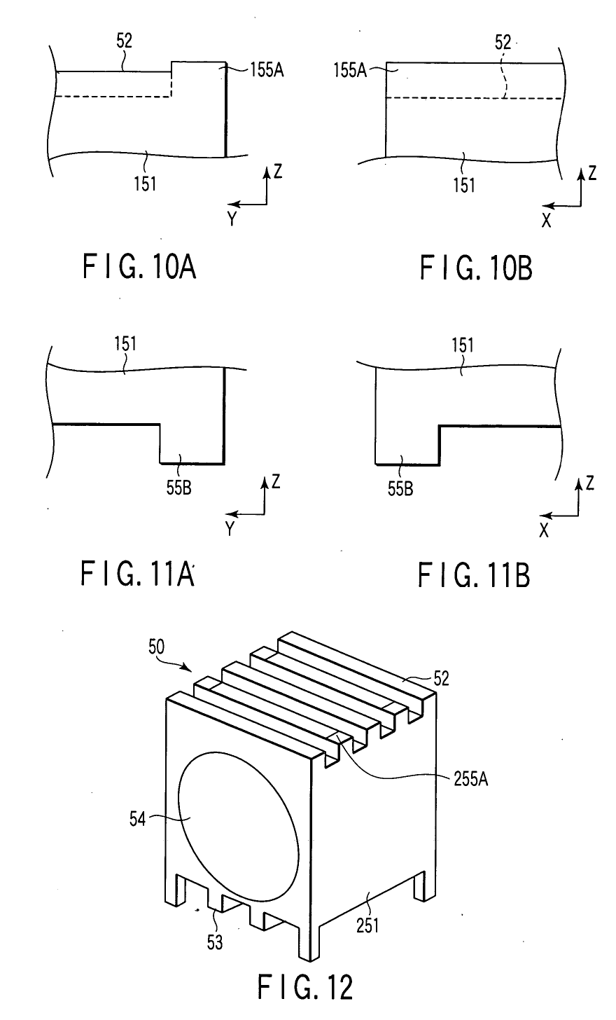

FIG. 9 is a perspective view schematically showing a first movable section 150 in an electrostatic actuator according to a second embodiment of the present invention. FIGS. 10A and 10B are a front view and a side view of a part of the first movable section 150 shown in FIG. 9 which part is shown by reference character A. FIGS. 11A and 11B are a front view and a side view of a part of the first movable section 150 shown in FIG. 9 which part is shown by reference character B. Components of the second embodiment shown by reference numerals from FIGS. 1 to 8 or the same components as those shown in FIGS. 1 to 8 have the same reference numerals and will not be described below.

The first movable section 150 comprises a substantially parallelepiped support 151 formed of a conductive material having a hollow portion, similarly to the first movable section 50 in the first embodiment. The support 151 can be formed by, for example, physically grinding or chemically etching a conductive material. Alternatively, the support 151 may be formed by injecting a conductive resin.

Stoppers 155A are be provided on the surface of the movable-section driving electrode 52. The stoppers 155A are provided so that when the first movable section 150 moves in the direction X of the optical axis, a gap is created between the driving electrodes 42A to 42D and the movable-section driving electrode 52, with the stoppers 155A lying opposite the stoppers 42E. The stoppers 155A are formed like bands, that is, stripes so that the optical axis direction X of the support 151 corresponds to a longitudinal direction and so that the plurality of movable-section driving electrodes 52 are connected together.

For the design value for the gap between the driving electrodes 42A to 42D and the movable-section driving electrode 52, the minimum value is 3 μm and the maximum value is 15 μm when the first movable section 150 moves in the optical axis direction X. The design value does not contain an error resulting from machining or assembly of the support 151, driving electrode substrate 42, or holding electrode substrate 43. For example, with the above method for manufacturing the driving electrode substrate 42 and holding electrode substrate 43, about 1.0 μm to 3.0 μm is a suitable value for the height of the stoppers 155A from the surface of the movable-section driving electrode 52.

In the image pickup apparatus 10 and zoom lens unit 30 configured as described above, the stoppers 155A are provided opposite the stoppers 42E as in the case of the first embodiment. This configuration can reduce the possibility of the following phenomenon even if the first movable section 50 is deformed by stress remaining in it or a variation in temperature or humidity: the driving electrodes 42A to 42D come into contact with the first movable section 150 to cause a short circuit between the driving electrodes 42A to 42D and the first movable section 150, thus damaging the image pickup apparatus 10.

Further, each stopper 155A is provided opposite the corresponding stopper 42E. This minimizes the magnitude of the dimensional error between each stopper 42E and the corresponding stopper 155A. A marked dimensional error between the stopper 42E and the stopper 155A may contact the driving electrodes 42A to 42D with the first movable section 150.

If only the stoppers 42E or 155A are provided, when the height of the stoppers 42E or 155A is increased to avoid the contact between the driving electrodes 42A to 42D and the first movable section 150, the magnitude of the dimensional error increases. The stoppers 42E are provided using, for example, such a thin film process as shown in FIGS. 4A to 4H. To increase the height of the stoppers 42E, it is necessary to increase the thickness of each layer or the number of layers of thin films. However, an increase in the thickness of each layer or in the number of thin film layers may increase the magnitude of an error in height of the stoppers 42E. Further, in this case, film stress may cause the driving electrode substrate 42 to be warped. This increases the possibility of contacting the driving electrodes 42A to 42D with the first movable section 150.

Further, for example, the stoppers 155A are formed by injecting a conductive resin such as PPS. One of the dimensional errors in injection molding is molding shrinkage. Molding shrinkage results from the ratio of the dimensions of the molding. That is, higher stoppers 155A are accompanied by more significant molding shrinkage. This may increase the possibility of contacting the driving electrodes 42A to 42D with the first movable section 150.

Accordingly, the magnitude of the dimensional error between the stopper 42E and the stopper 55A is minimized by providing each stopper 155A opposite the corresponding stopper 42E. This configuration can reduce the possibility of the following phenomenon even if the first movable section 150 is deformed by stress remaining in it or a variation in temperature or humidity: the driving electrodes 42A to 42D come into contact with the first movable section 150 to cause a short circuit between the driving electrodes 42A to 42D and the first movable section 150, thus damaging the image pickup apparatus 10.

Further, for the design value for the gap between the driving electrodes 42A to 42D and the movable-section driving electrode 52, the minimum value is 3 μm when the first movable section 150 moves in the optical axis direction X. This configuration can reduce the possibility of the following phenomenon even if the first movable section 150 is deformed by stress remaining in it or a variation in temperature or humidity: the driving electrodes 42A to 42D come into contact with the first movable section 150 to cause a short circuit between the driving electrodes 42A to 42D and the first movable section 150, thus damaging the image pickup apparatus 10.

For the design value for the gap between the driving electrodes 42A to 42D and the movable-section driving electrode 52, the maximum value is 15 μm when the first movable section 150 moves in the optical axis direction X. Consequently, a strong attractive force is exerted between the driving electrodes 42A to 42D and the movable-section driving electrode 52. That is, the design value results in a sufficient force to attract the first movable section 150. This allows the first movable section to move more smoothly.

The stoppers 155A are provided so as to connect the plurality of movable-section driving electrodes 52 together. This improves the rigidity of the support 151 which resists the bending in the direction in which the support 151 forms a curve in the optical axis direction X.

The support 151 has an internal stress generated during for example, injection molding. The movable-section driving electrodes 52 are shaped like concaves and convexes arranged in parallel in the moving direction X. Consequently, the internal stress of the support 151 may warp the support 151 in the direction in which the support 151 forms a curve in the optical axis direction. However, since the stoppers 155A are provided so as to connect the plurality of movable-section driving electrodes 52, the stoppers 155A reinforce the support 151. This improves the rigidity of the support 151 which resists the bending in the direction in which the support 151 forms a curve in the optical axis direction X.

In the description of the second embodiment, the stoppers 155A are provided only on the first movable section 150. However, the stoppers may be provided on the second movable section 60.

Specifically, the stoppers may also be provided on the surface of the support 61. The stoppers may be provided so that when the second movable section 60 moves in the direction X of the optical axis, a gap is created between the driving electrodes 42A to 42D and the movable-section driving electrode 62, with the stoppers lying opposite the stoppers 42E.

For the design value for the gap between the driving electrodes 42A to 42D and the movable-section driving electrode 62, the minimum value is 3 μm and the maximum value is 15 μm when the second movable section 60 moves in the optical axis direction X. The design value does not contain an error resulting from machining or assembly of the support 61, driving electrode substrate 42, or holding electrode substrate 43. For example, with the above method for manufacturing the driving electrode substrate 42 and holding electrode substrate 43, about 1.0 μm to 3.0 μm is a suitable value for the height of the stoppers from the surface of the movable-section driving electrode 62.

The stoppers may also be provided on the surface of the second movable-section electrode 63. The stoppers may be provided so that when the second movable section 60 moves in the direction X of the optical axis, a gap is created between the stripe electrodes 43A and 43B and the second movable-section electrode 63, with the stoppers lying opposite the stoppers 43E.

It should not be understood that the detailed description of the embodiments and the drawings limit the present invention. Various alternatives, embodiments, operating techniques may occur to those skilled in the art in view of the disclosure.

For example, each stopper 55A according to the first embodiment shown in FIG. 5 is provided in the corresponding corner of the first movable section 50. However, as shown in FIG. 12, the stopper 255A may be provided in an area different from the corners of the support 251 for the first movable section 50. Further, four stoppers 55A are shown in the figures. However, the number is not particularly limited to four provided that movement of the first movable section 50 is hindered. That is, the stopper 55A may be provided in any part of the first movable section 50 provided that it is located opposite the corresponding stopper 42E.

As described above, with the electrostatic actuator and the image pickup apparatus into which the electrostatic actuator is incorporated according to the present invention, it is possible to reduce the possibility of destroying the image pickup apparatus if the movable section is deformed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electrostatic actuator comprising:
a stator;
a first and second substrates arranged in the stator so as to be faced each other, the second substrate being provided with first convex portions;
a movable section guided in the stator so as to be movable in a predetermined direction, the movable section being provided with second convex portions which are faced to the first convex portions, respectively;
a holding electrode provided on the first substrate to attract and hold the movable section;
first electrodes provided on the second substrate at a first pitch in the predetermined direction; and
second electrodes provided on the movable section at a second pitch in the predetermined direction, which is faced to the first electrodes so as to drive the movable section, the first and second convex portions forming a gap between the first electrodes and the second electrodes.

2. The electrostatic actuator according to claim 1, wherein the gap is substantially set in a range between 3 μm and 15 μm.

3. The electrostatic actuator according to claim 1, further comprising
a second movable section arranged in the stator to be separated from the first movable section and guided in the stator so as to be movable in the predetermined direction, the movable section being provided with third convex portions which are faced to the first convex portions, respectively; and
third electrodes provided on the second movable section at the second pitch in the predetermined direction, which is faced to the first electrodes so as to drive the movable section, the first and third convex portions forming a gap between the first electrodes and the third electrodes.

4. The electrostatic actuator according to claim 1, wherein the second convex portions has a diamond like carbon surface.

5. The electrostatic actuator according to claim 1, wherein the second convex portions has a diamond like carbon film or films selectively formed on the second convex portion.

6. An image pickup apparatus comprising:
a stator;
a first and second substrates arranged in the stator so as to be faced each other, the second substrate being provided with first convex portions;
a movable section guided in the stator so as to be movable in a predetermined direction, the movable section being provided with second convex portions which are faced to the first convex portions, respectively;
a holding electrode provided on the first substrate to attract and hold the movable section;
first electrodes provided on the second substrate at a first pitch in the predetermined direction;
second electrodes provided on the movable section at a second pitch in the predetermined direction, which is faced to the first electrodes so as to drive the movable section, the first and second convex portions forming a gap between the first electrodes and the second electrodes;
a lens provided in the movable section to transfer an image of a subject; and
an image pickup device arranged to detect the image of the subject transferred from the lens.

7. The image pickup apparatus according to claim 6, wherein the gap is substantially set in a range between 3 μm and 15 μm.

8. The image pickup apparatus according to claim 6, further a second movable section arranged in the stator to be separated from the first movable section and guided in the stator so as to be movable in the predetermined direction, the movable section being provided with third convex portions which are faced to the first convex portions, respectively; and
third electrodes provided on the second movable section at the second pitch in the predetermined direction, which is faced to the first electrodes so as to drive the movable section, the first and third convex portions forming a gap between the first electrodes and the third electrodes.

9. The image pickup apparatus according to claim 6, wherein the second convex portions has a diamond like carbon surface.

10. The image pickup apparatus according to claim 6, wherein the second convex portions has a diamond like carbon film or films selectively formed on the second convex portion.
